(19) United States
(12) Patent Application Publication
(10) Pub. No.: US 2005/0200668 A1
(43) Pub. Date: Sep. 15, 2005

(54) Continually ink-supplying device for an inkjet printer

(76) Inventor: Pao-Hung Ieh, Tainan (TW)

Correspondence Address: PRO-TECHTOR INTERNATIONAL, 20775 Norada Court, Saratoga, CA, 95070-3018, US

(21) Appl. No.: 10/797,654

(22) Filed: Mar. 9, 2004

(51) Int. Cl. B41J 2/175

(52) U.S. Cl. 347/85

(57) ABSTRACT

A continually ink-supplying device for an inkjet printer includes a plurality of ink containers positioned on an upper or a vertical side of an inkjet printer and a plurality of guide tubes respectively connecting each said ink container with a ink tube or a ink cartridge of a printer. Each ink container has a tube hole and an ink hole closed with a cap. The guide tube is inserted through the tube hole, having its front end reaching to the inner bottom of the ink container, and having its rear end connected with an ink tube or an ink cartridge of the printer. Then the ink container is made transparent or semi-transparent to be visible to let a user know readily the quantity of the ink stored therein, and the user can refill readily to prevent ink from interrupted in printing.

### BACKGROUND OF THE INVENTION

1. Field of the Invention

This invention relates to a continually ink-supplying device for an inkjet printer, particularly to one possible to refill ink without taking off an ink cartridge so as to store a large quantity of ink and to accurately supply ink as well, with the ink stored therein visible and easy to refill, supplying ink continually. Then the printer can be lowered in its cost, saving work and time for filling the ink cartridge and upgrading work efficiency.

2. Description of the Prior Art

FIGS. 1 and 2 show a conventional inkjet printer 1, which includes a table 11, and a plurality of ink cartridges 12 positioned in the table. The ink cartridges are inserted therein from the front side to the rear side, having plural outlet valves 121, and a needle 111 inserted in the front end of each outlet valve 121, an ink tube 13 connecting the front end of the needle 111 with a nozzle (not shown) of a large inkjet printer 1.

The ink cartridge 12 is seal-style container deposited in the table 11, and the quantity of ink stored therein is only indicated on a panel of the table 11, impossible to check it readily, potentially leading to ink interruption, incomplete printing, etc. to require replacing of the ink cartridge 12, repetition of printing, resulting in material and work waste. Moreover, the remaining ink in the ink tube 13 has to be cleaned out forcefully after the replacement of the ink cartridge 12, Thus, the ink cartridge 12 has to be replaced at once whenever it is used up, or the ink may not continue to come out for printing to cause interruption. Therefore, a user may be obliged to prepare in advance a plurality of ink cartridges 12 for preventing ink interruption, making up a nuisance.

Next, FIG. 3 shows a condition for refilling ink after the ink cartridge 12 is pulled out, and FIGS. 4 and 5 show an ink cartridge 21 of a conventional small inkjet printer 2 being filled with ink, and a special ink-injecting cylinder 3 is used for filling ink in the ink cartridge 21. The ink-injecting cylinder 3 consists of an outer cylinder 31, a threaded cap 32, an inner cylinder 33 and an anti-leak ring 34. The outer cylinder 31 has an inner surface 311, a sealing surface 312 and a threaded tube 313 with a through hole 314 extending from the sealing surface 312 to insert in the ink cartridge 21. The threaded cap 32 screws with the threaded tube 313, having a front end formed with a cone-shaped tubular needle 321. The inner cylinder 33 is movably positioned around the inner surface of the outer cylinder 31, transparent, having an upper end and a bottom end formed with a projection 331 and an annular position member 332. The anti-leak ring 34 is fitted around the annular position member 332, having a contact ring 341 around its outer surface to contact with the inner surface 311 of the outer cylinder 31.

The inner cylinder 33 stores a proper quantity of ink 35 therein, with the tubular needle 321 of the threaded cap 32 inserted in the ink cartridge 12, 21. A user can hold the outer cylinder 31, and pushes the projection 331 of the inner cylinder 33 upward with the thumb, forcing the ink 35 in the inner cylinder 33 to flow down gradually to the bottom of the outer cylinder 31, with the interior of the ink cartridge 12, 21 becoming minus pressure. Then a user releases the inner cylinder 33 to let the ink 35 sucked in the ink cartridge 12, 21 automatically by the minus pressure, effecting the purpose of filling ink 35. But this conventional structure has the following flaws.

1. As the tubular needle 321 is very short, its outer end only reaches the upper end of the sponge member 4 in the ink cartridge 12, 21, separated from the sponge member 4, so when the ink 35 is injected through the tubular needle 321 in the ink cartridge 12, 21, the ink may be slow to flow through the sponge member 4. Then a user has to wait quite a while until the ink completely flows in the ink cartridge 12, 21. Thus, when in a hurry, a user may feel very nervous for the slow motion of ink filling. Furthermore, when the sponge 4 is quite dry, or used for the first time, the ink may take more time in flowing down in the ink cartridge 12, 21.

2. After filling ink is finished, the ink 3 5 may still remain in the upper space 41 of the ink cartridge 12, 21, and if a user is not aware of the condition, the ink is apt to overflow out of the ink cartridge 12, 21 when it is deposited in the printer for use, smearing the hand of the user, the paper or the printer itself.

### SUMMARY OF THE INVENTION

This invention has been devised to offer a continually ink-supplying device for an inkjet printer, which does not need to often replace an ink cartridge, able to know the quantity of ink stored therein and continually supply ink to the nozzle of an inkjet printer,

The feature of the invention is plural ink containers and guide tubes respectively connected with the ink containers to correspond to an ink tube or an ink cartridge of an inkjet printer. Each ink container is positioned on an upper or a vertical side of the printer, having a tube hole and an ink-filling hole. Each guide tube is inserted through a tube hole of the ink container, having its front end reaching to and secured with the inner bottom of the ink container and its rear end connected with an ink tube of the nozzle of the printer.

### BRIEF DESCRIPTION OF DRAWINGS

This invention will be better understood by referring to the accompanying drawings, wherein:

FIG. 1 is a front view of a conventional large inkjet printer;

FIG. 2 is a cross-sectional view of a table with an ink cartridge of the conventional large inkjet printer;

FIG. 3 is a perspective view of the ink cartridge and a ink injecting cylinder of the conventional large inkjet printer;

FIG. 4 is a cross-sectional view of filling ink in an ink cartridge of a conventional small inkjet printer;

FIG. 5 is a cross-sectional view of filling ink in the ink cartridge of the conventional small inkjet printer, showing an inner cylinder of the ink-injecting cylinder being pushed upward;

FIG. 6 is a cross-sectional view of a table with an ink cartridge of a large inkjet printer in the present invention;

FIG. 7 is a perspective view of the table with plural ink cartridges of a large inkjet printer in the present invention;

FIG. 8 is a perspective view of ink cartridges of a small inkjet printer in the present invention;

FIG. 9 is a front view of a second embodiment of a continually ink-supplying device for an inkjet printer in the present invention; and, FIG. 10 is a side view of the second embodiment able to be hung of a continually ink-supplying device for an inkjet printer in the present invention.

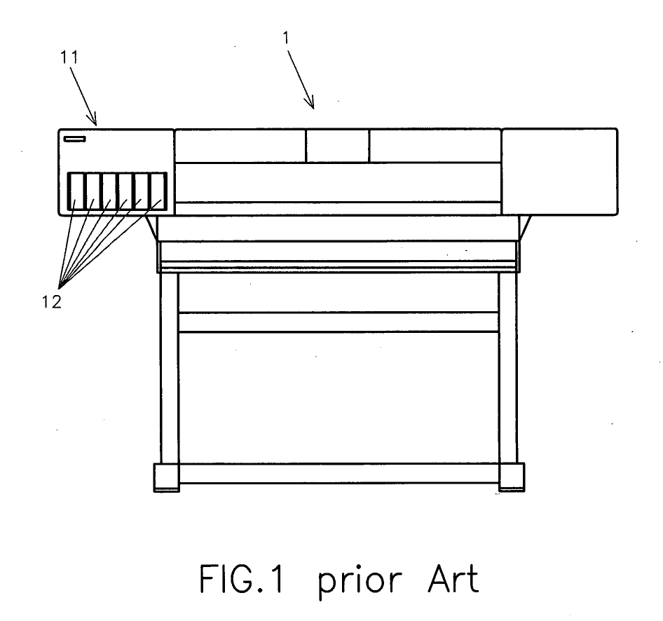

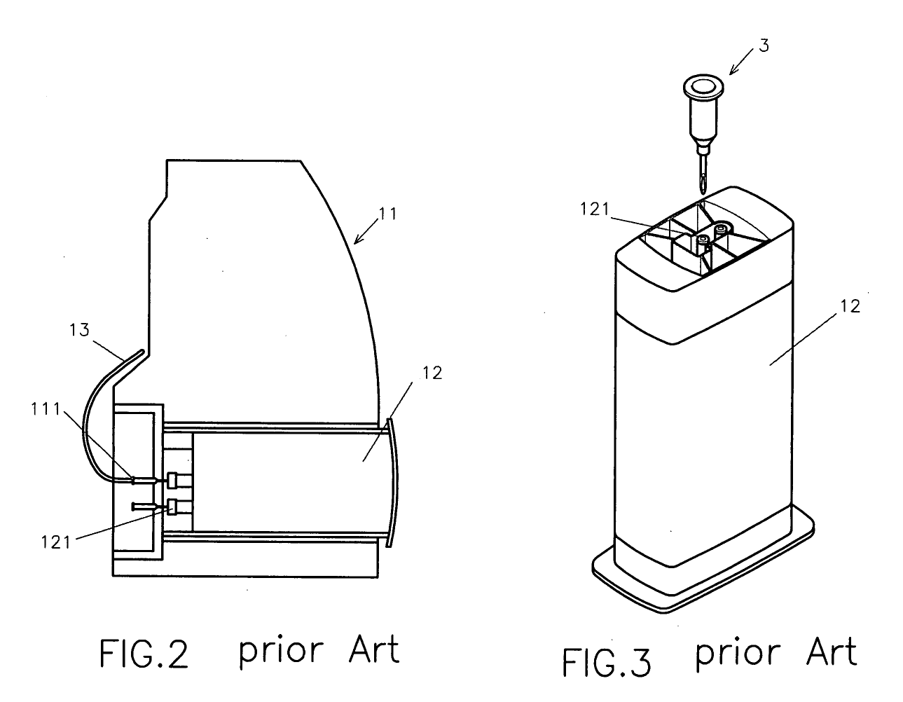

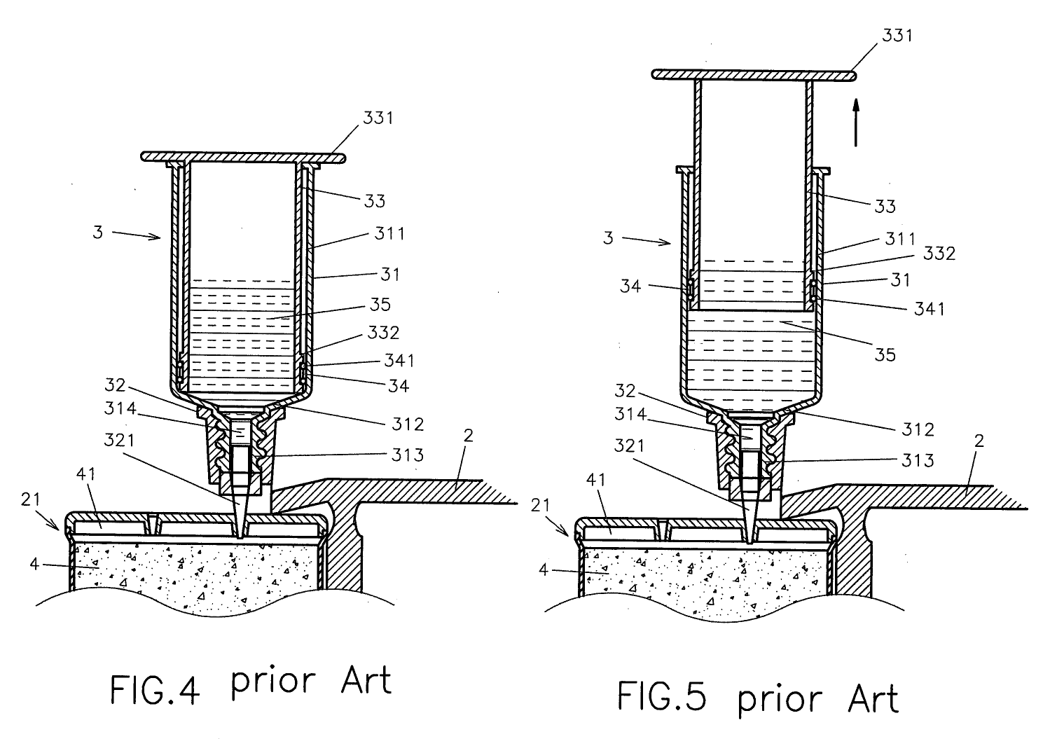

### DETAILED DESCRIPTION OF THE PREFERRED EMBODIMENTS

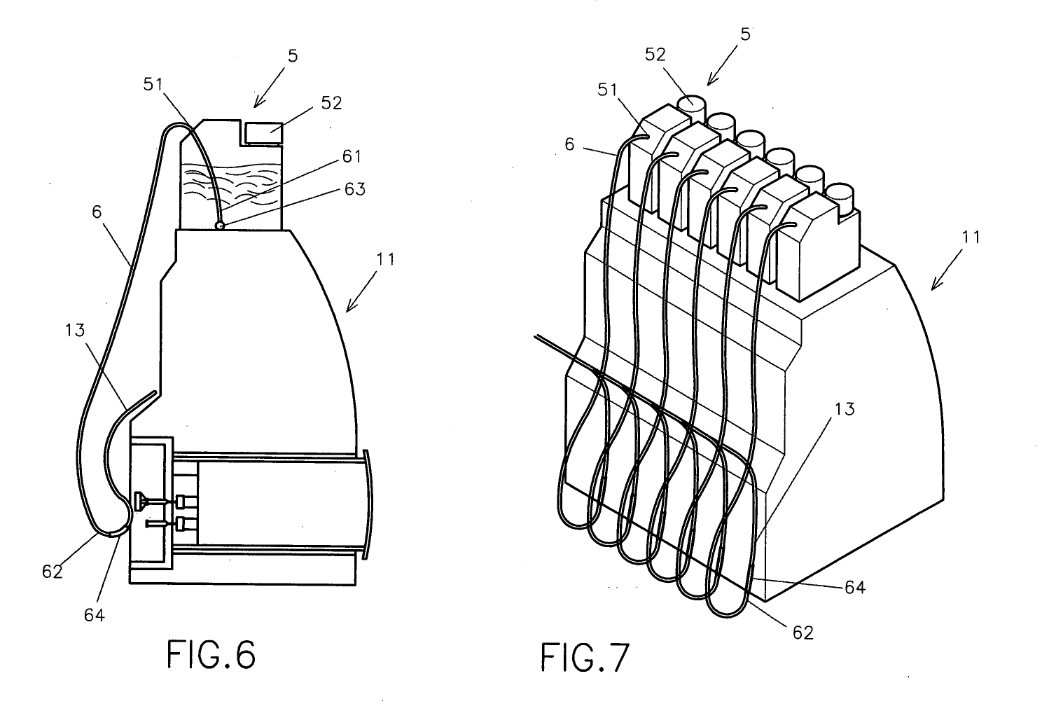

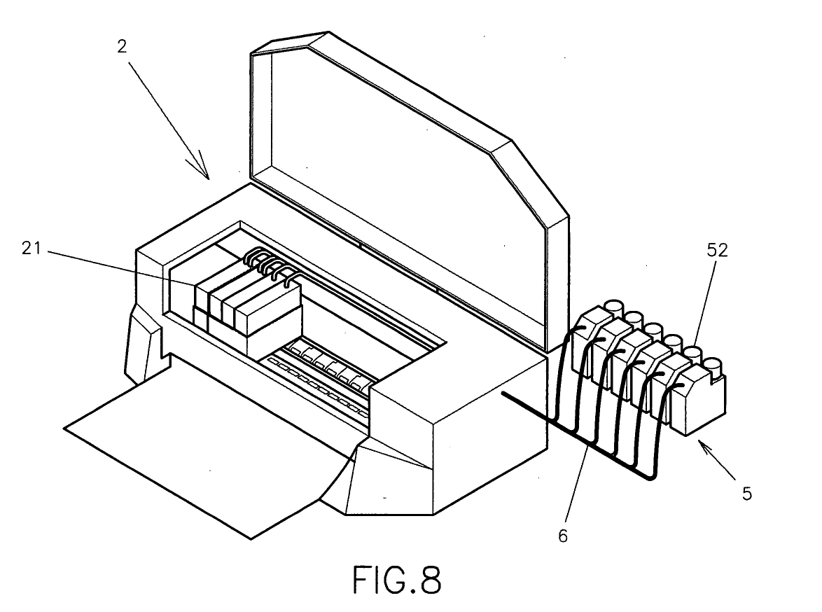

A first embodiment of a continually ink-supplying device for a small or large inkjet printer 1 or 2 in the present invention, as shown in FIG. 6, includes a plurality of ink containers 5 and guide tubes 6 positioned at an upper or a vertical side of the printer 1 or 2, connected with an ink tube 13 and an ink cartridge 12, or 21 of the printer 1 or 2.

Each ink container 5 has a tube hole 51 bored in a front sloped surface, and an ink hole bored in a rear flat surface and a cap 52 closed on the ink hole.

Each guide tube 6 has its front end 61 inserted through the ink hole 51 of each ink container 5 and extending in the interior of the ink container 5, and a retainer 63 with many tine holes for ink to flow through to secure the front end 61 of the guide tube 6 on an inner bottom of the ink container 5. Further, the guide tube 6 has a smaller diameter than that of the tube hole 51, allowing air possible to flow in the container 5 so as to balance the inner pressure in the container with the outer air pressure.

The continually ink-supplying device in the invention utilizes the ink containers 5 made of a transparent or semi-transparent material for storing a large quantity of ink and visible to be seen the height of the ink stored therein so a user can readily refill ink. In order to refill ink. the cap 52 is only opened for the purpose, very easy and convenient to handle. Therefore, ink can continue to be supplied and never be interrupted, not wasting time and work, never smearing the hand of user, papers or the printer itself by leaking ink, and not needing to prepare extra ink cartridges.

If the continually ink-supplying device is to be used in a large inkjet printer 1, as shown in FIG. 6 and 7, a hollow connect tube 64 is used to connect the rear end 62 of the guide tube 6 with the ink tube 13 connected with the nozzle of the printer 1.

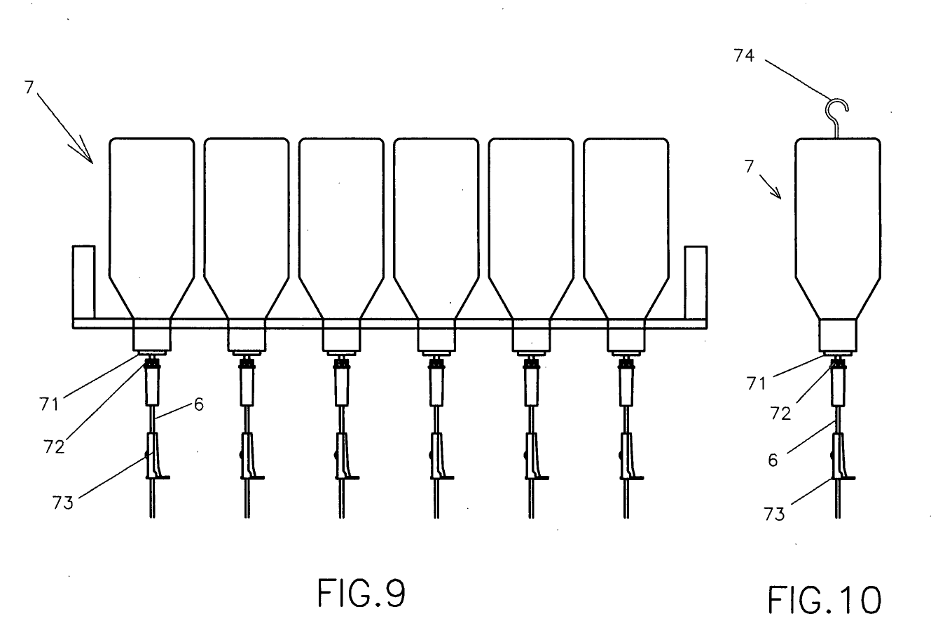

Further, FIG. 9 shows a second embodiment of a continually ink-supplying device in the invention, which includes an ink container 7 shaped sealed and having a rubber stopper 7 1 fitted in its bottom, and a tubular needle 72 inserting through the stopper 71 into the interior of the ink container 7 and having its rear end connected with the guide tube 6 fixed with a quantity adjuster 73 for controlling the quantity of ink flowing through the guide tube 6.

Next, a hanger hook 74 can be attached with the upper end of each ink container 7 to make it possible to be hung up on a different location, as shown in FIG. 10.

While the preferred embodiments of the invention have been described, it will be recognized and understood that various modifications may be made therein, and the appended claims are intended to cover all such modifications that may fall within the spirit and scope of the invention.

1. A continually ink-supplying device for an inkjet printer, said device comprising:
A plurality of ink containers to correspond to an ink tube or an ink cartridge of an inkjet printer, each said ink container positioned at an upper side or a vertical side of an inkjet printer and provided with a tube hole and an ink hole closed with a cap:
A plurality of guide tubes respectively inserted through said ink tube hole of each said ink container, each said guide tube having its front end extending in the interior of each said container to its inner bottom, a rear end of each said guide tube connected with an ink tube of a nozzle of a large inkjet printer or directly connected with an ink cartridge of a small inkjet printer.

2. The continually ink-supplying device for an inkjet printer as claimed in claim 1, wherein each said guide tube has its front end fixed with a retainer provided with many tiny holes for ink to flow through, and said retainer can secure the front end of each said guide tube on an inner bottom of said ink container.

3. The continually ink-supplying device as claimed in claim 1, wherein a hollow connect tube is further connected between the rear end of each said guide tube and the ink tube of the nozzle of a large inkjet printer.

4. The continually ink-supplying device as claimed in claim 1, wherein each said ink container is shaped sealed, having a rubber stopper in its bottom and a tubular needle inserting in said rubber stopper and connected with said guide tube.

5. The continually ink-supplying device as claimed in claim 1, wherein each said guide tube has a quantity adjuster fixed thereon for controlling the ink volume flowing through said guide tube.

6. The continually ink-supplying device as claimed in claim 1, wherein said each ink container further has a hanger hook on its upper end.

7. The continually ink-supplying device as claimed in claim 4, wherein each said guide tube has a quantity adjuster fixed thereon for controlling the ink volume flowing through said guide tube.

8. The continually ink-supplying device as claimed in claim 4, wherein said each ink container further has a hanger hook on its upper end.
